(19) United States
(12) Patent Application Publication
(10) Pub. No.: US 2025/0373413 A1
(43) Pub. Date: Dec. 4, 2025

(54) PSEUDONYMIZED DATA ENRICHMENT

(71) Applicant: TRANS UNION LLC, Chicago, IL (US)

(72) Inventors: Matthew DAUNER, Chicago, IL (US); Patrick WHITE, Chicago, IL (US); Richard FAZIO, Chicago, IL (US); Shakeel SYED, Chicago, IL (US)

(21) Appl. No.: 19/224,308

(22) Filed: May 30, 2025

Related U.S. Application Data
(60) Provisional application No. 63/654,581, filed on May 31, 2024.

(51) Int. Cl. H04L 9/08; H04L 9/32

(52) U.S. Cl. CPC H04L 9/0819; H04L 9/3236

(57) ABSTRACT

A request for enrichment data for enriching user data for a plurality of users may be received from a user device within a first data environment. The request may include, for each user, a respective encryption key used to encrypt the respective user data, respective encrypted user data, and an indication of a respective hashing rule used to generate the respective encryption key. The encrypted user data for the users may be decrypted in a second data environment using the encryption keys. The hashing rule may be used to generate pseudonymized representations of the decrypted user data. The pseudonymized representations of the decrypted user data may be mapped to pseudonymized representations of the enrichment data that correspond to the user data. The pseudonymized representations of the decrypted user data mapped to the pseudonymized representations of the enrichment data may be sent to the user device within the first data environment.

### CROSS-REFERENCE TO RELATED APPLICATION

This application claims the benefit of U.S. Provisional Patent Application No. 63/654,581, filed on May 31, 2024, the contents of which are hereby incorporated by reference in their entirety.

### BACKGROUND

In the digital age, various online services and applications generate, collect, and store vast user data. This user data, which can include sensitive data (e.g., personal identifying information (PII), regulated user data, etc.), usage patterns, preferences, and behaviors, is invaluable for entities (e.g., businesses, information management platforms, etc.) seeking to enhance their services, facilitate user-related transactions, generate user-targeted content/service campaigns, and improve user experiences. However, managing user data poses significant challenges, particularly in maintaining privacy, security, and compliance with data protection regulations. Traditional systems that manage user data often involve directly handling PII (e.g., user names, addresses, social security numbers, etc.). This exposure of PII creates significant risks, including, but not limited to, data breaches that enable unauthorized access to sensitive data, identity theft, entity trust erosion due to concerns about user data privacy, and the like.

### SUMMARY

Provided herein are system, apparatus, device, method, and/or computer program product embodiments, and/or combinations and sub-combinations thereof, for a novel approach to pseudonymized data enrichment. A request for enrichment data for a plurality of users may be received from a user device within a first data environment. The request may include for each user, a respective encryption key used to encrypt the respective user data, respective encrypted user data, and an indication of a respective hashing rule used to generate the respective encryption key. The respective encrypted user data for each user of the plurality of users may be decrypted in a second data environment using the encryption keys. The respective hashing rule for each user of the plurality of users may be used to generate respective pseudonymized representations of the respective decrypted user data. The respective pseudonymized representations of the decrypted respective user data for each user of the plurality of users may be mapped to pseudonymized representations of the enrichment data that correspond to the respective user data. The pseudonymized representations of the decrypted user data for each user of the plurality of users mapped to the pseudonymized representations of the enrichment data may be sent to the user device within the first data environment.

### BRIEF DESCRIPTION OF THE DRAWINGS

The accompanying drawings are incorporated herein and form a part of the specification.

FIG. 1 is a block diagram of an example system for pseudonymized data enrichment, according to some aspects of this disclosure.

FIG. 2 is a flowchart of an example method for pseudonymized data enrichment, according to some aspects of this disclosure.

FIG. 3 is a flowchart of an example method for pseudonymized data enrichment, according to some aspects of this disclosure.

FIG. 4 is an example of a computer system useful for implementing various aspects of this disclosure.

In the drawings, like reference numbers generally indicate identical or similar elements. Additionally, generally, the leftmost digit(s) of a reference number identifies the drawing in which the reference number first appears.

### DETAILED DESCRIPTION

Provided herein are system, apparatus, device, method and/or computer program product embodiments, and/or combinations and sub-combinations thereof, for pseudonymized data enrichment. References herein to “pseudonymized” data refer to any information that has undergone a process of replacing personally identifiable information (PII) with artificial identifiers or pseudonyms so that the data cannot directly identify an individual without additional information. Entities may integrate first-party data (e.g., information collected directly by an entity from its users, customers, etc.) with third-party data (e.g., information collected by an entity that does not have a direct relationship with the users from whom the data is sourced, etc.) from various sources. The first-party data may include information that is known only to the first party and the third-party data may include information that is known only to the third party. For example, a car dealership (e.g., a first party) may want to identify a specific pool of customers from its database, such as all customers satisfying a particular credit score that trade in a previously purchased vehicle for a new vehicle. The car dealership may also want to further define the pool of customers based on information that indicates factors important to the car dealership, such as information from an external vehicle service center (e.g., third party) that indicates the vehicle service history of customers that trade in a previously purchased vehicle for a new vehicle. The car dealership (e.g., first party) may want to identify the pool of customers from its database based on this criteria while still maintaining the customers' privacy by not knowing what the actual credit scores are, to generate customized explainable analytics. Again, this is just an example scenario of when an entity may want to combine first-party data with third-party data (or any other data) to generate insights. However, a person of ordinary skill of the art understands that there may be many applicable scenarios.

To combine data from different sources, entities may use traditional analysis platforms to perform a lookup at a time when user data is collected and append contextual information into a log file. However, this burdens the analysis platform by increasing the amount of stored information. Additionally, it is essential to maintain an original data log file for compliance purposes, requiring the traditional analysis platforms to replicate the original data prior to combination. Further, handling sensitive data (e.g., personal identifying information (PII), regulated user data, etc.), such as credit scores and/or the like, poses significant privacy risks including, but not limited to, nefarious interception of transmitted sensitive data, data breaches, improper retention and disposal policies for sensitive data, and/or the like. According to some aspects of this disclosure, unintended exposure of sensitive data during data transfer or data combination is a technological problem resolved by the system, apparatus, device, method and/or computer program product embodiments, and/or combinations and sub-combinations thereof, for pseudonymized data enrichment described herein.

According to some aspects of this disclosure, to address the issue of unintended exposure of sensitive data, an entity-controlled user device may have proprietary data (e.g., first-party data, etc.) from within its private domain, infrastructure, computing platform, and/or data environment pseudonymized and combined/enriched with pseudonymized user information (e.g., sensitive data) which is maintained in the secure environment of a separate entity. The combined data may then be imported back into the private domain, infrastructure, computing platform, and/or data environment to be analyzed for custom insights. According to some aspects of this disclosure, sensitive information, such as user information containing user-level PII and/or the like, may be desensitized (e.g., depersonalized, etc.) via cryptographic links to common identifiers that obfuscate the PII. First-party data (and/or third-party data) may be linked to and enriched by the sensitive data in a secure data domain to avoid unintended exposure of sensitive data. Enriched data may be used to generate analytical models, enable comprehensive data analysis and improved service personalization, and facilitate a wide range of analytical tasks including, but not limited to, risk and marketing analysis, account management, campaign generation, prescreening, and/or the like.

According to some aspects of this disclosure, pseudonymized data enrichment, as described herein, improves and advances at least the technical field of privacy protection by ensuring that user identifiers and data remain pseudonymized throughout a data enrichment process. Encryption and pseudonymization prevent direct exposure of user PII, insulating sensitive data from data breaches and unauthorized access. According to some aspects of this disclosure, pseudonymized data enrichment, as described herein, improves and advances the technical field of data enrichment by offering a privacy-preserving solution to the challenges of securely sharing and enhancing user data. Unlike traditional data enrichment methods that routinely rely on sharing personal identifiers, pseudonymized data enrichment, as described herein, leverages pseudonymization and encryption to facilitate matching of identities across datasets while isolating data, enriching users and raw data providers into separate data domains. By utilizing pseudonymized representations and encryption keys, pseudonymized data enrichment, as described herein, enables a safe and efficient transfer of data between different data domains and/or environments. Pseudonymized data enrichment, as described herein, reduces the need for complex data-handling protocols while ensuring privacy protection. As described herein, data enrichment may occur while reducing users' exposure to potential risks, thus promoting responsible and secure data usage and exchange.

By enabling privacy-preserving data transfers and enrichments, the aspects described herein enhance the technological fields of data processing and data security by making it easier for entities to improve their private data and services without compromising sensitive data. These and other technological advantages are described herein.

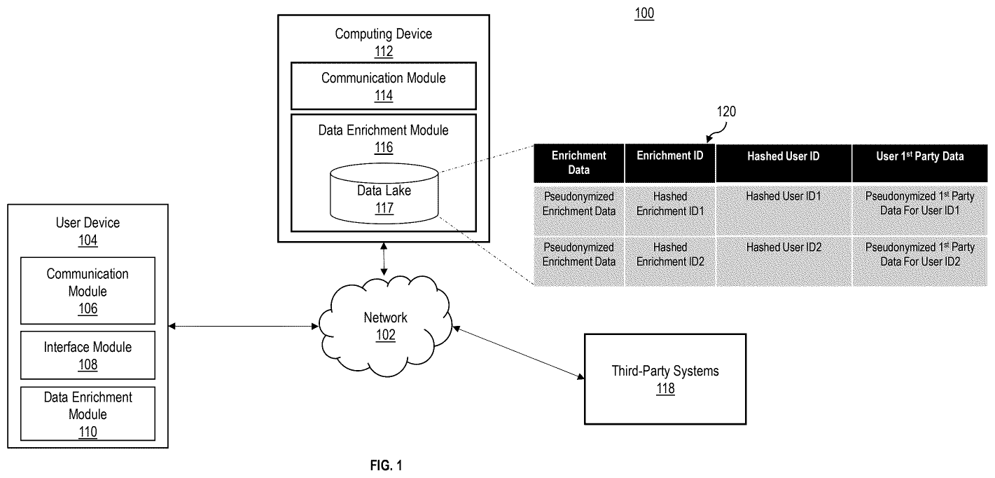

FIG. 1 shows a block diagram of an example system 100 for pseudonymized data enrichment. System 100 is merely an example of one suitable system environment and is not intended to suggest any limitation as to the scope of use or functionality of aspects described herein. Neither should system 100 be interpreted as having any dependency or requirement related to any single device/module/component or combination of devices/modules/components described therein.

According to some aspects of this disclosure, system 100 may include a network 102. According to some aspects of this disclosure, network 102 may include a packet-switched network (e.g., internet protocol-based network), a non-packet-switched network (e.g., quadrature amplitude modulation-based network), and/or the like. According to some aspects of this disclosure, network 102 may include network adapters, switches, routers, modems, and the like connected through wireless links (e.g., radiofrequency, satellite) and/or physical links (e.g., fiber optic cable, coaxial cable, Ethernet cable, or a combination thereof). Network 102 may include public networks, private networks, wide area networks (e.g., Internet), local area networks, and/or the like. According to some aspects of this disclosure, network 102 may include a content access network, content distribution network, and/or the like. According to some aspects of this disclosure, network 102 may provide and/or support communication from telephone, cellular, modem, and/or other electronic devices to and throughout the system 100. For example, system 100 may include and support communications between user device 104, computing device 112, and third-party systems 118 via network 102.

According to some aspects of this disclosure, user device 104 may be part of an entity-controlled domain, infrastructure, computing platform, and/or data environment. According to some aspects of this disclosure, user device 104 may represent a plurality of user devices in communication and/or interoperability within an entity-controlled domain, infrastructure, computing platform, and/or data environment. Although only user device 104 is shown, system 100 may include any number of user devices.

According to some aspects of this disclosure, user device 104 may include, for example, a smart device, a mobile device, a laptop, a tablet, a display device, a computing device, a server, or any other device capable of communicating with computing device 112, third-party systems 118, and/or any other device/component of system 100, either described or unshown. User device 104 may include communication module 106 that facilitates and/or enables communication with network 102 (e.g., devices, components, and/or systems of network 102, etc.), computing device 112, and/or any other device/component of system 100. For example, communication module 106 may include hardware and/or software to facilitate communication. According to some aspects of this disclosure, communication module 106 may include one or more of a modem, transceiver (e.g., wireless transceiver, etc.), digital-to-analog converter, analog-to-digital converter, encoder, decoder, modulator, demodulator, tuner (e.g., QAM tuner, QPSK tuner), and/or the like. According to some aspects of this disclosure, communication module 106 may include any hardware and/or software necessary to facilitate communication.

According to some aspects of this disclosure, user device 104 may include an interface module 108. Interface module 108 enables users to interact with device 104, network 102, computing device 112, and/or any other device/component of system 100. According to some aspects of this disclosure, interface module 108 may include one or more input devices and/or components, for example, a keyboard, a pointing device (e.g., a computer mouse, remote control), a microphone, a joystick, a tactile input device (e.g., touch screen, gloves, etc.), and/or the like. Interaction with the input devices and/or components may enable a user to interact with a user interface generated and/or displayed by the interface module 108 and/or the like.

According to some aspects of this disclosure, user device 104 may include a data enrichment module 110. Data enrichment module 110 may include any interface for presenting and/or receiving information, such as pseudonymized user data (e.g., historical transaction/pattern data, credit/reputation data, digital identity-related data, behavioral/usage data, etc.), to/from a user. Pseudonymization of the user data refers to the use of artificial identifiers to obfuscate/mask user PII. Pseudonymization of the user data provides an additional layer of privacy protection compared to raw, customer-specific data because the data cannot be reconnected to a specific person without access to a key (e.g., encryption key, etc.) or mapping information which is held separately in a secure data domain.

Data enrichment module 110 may include software, such as an application and/or the like configured on user device 104. Data enrichment module 110 may facilitate the exchange of pseudonymized user information between computing device 112 and third-party systems 118 while maintaining compliance with data protection regulations. Data enrichment module 110 may request or query various files from a local source (e.g., a storage module (not shown) configured with data enrichment module 110, etc.) and/or a remote source, such as computing device 112, third-party systems 118, and/or any other device/component of system 100. For example, interaction with input devices and/or components of interface module 108 may enable requests to be sent to computing device 112 for pseudonymized enrichment data related to collected user data without exposing sensitive data to computing device 112. According to some aspects of this disclosure, interaction with the input devices and/or components may enable requests to be sent to third-party systems 118 for third-party data related to collected user data without exposing sensitive data to third-party systems 118. Data enrichment module 110 may process input files containing user-level PII, identifier keys, and payload data to obfuscate the PII (e.g., depersonalizing it) and link records to a common identifier. After processing the input files, data enrichment module 110 may write pseudonymized enrichment data into data lake 117. Data enrichment module 110 may request or query various files from a local source (e.g., data lake 117, etc.) and/or a remote source, such as third-party systems 118, and any other device/component of system 100.

For example, a data lake 117 may store enrichment data (e.g., credit data, digital identity-related data, health-related data, financial data, etc.) that is keyed on a common enrichment data identifier, “enrichment ID.” An enrichment ID may serve as the central linking key for data enrichment of input datasets (e.g., data sets received from computing device 112 as further described below) via data enrichment module 110 and/or the like. The linkage between user data from user device 104 and enrichment data from computing device 112 may be indicated by an example pseudonymized identity graph 120. In identity graph 120, the user identifiers for two separate users have been hashed and are represented in the column titled ‘Hashed User ID’ as Hashed User ID1 and Hashed User ID2, respectively. Pseudonymized first-party data from user device 104 that is associated with the two users that are identified by Hashed User ID1 and Hashed User ID2, respectively, is represented in the column titled ‘User 1st Party Data’. The user identifiers for the two separate users represented in the column titled ‘Hashed User ID’ as Hashed User ID1 and Hashed User ID2 are mapped to pseudonymized enrichment data from computing device 112 that is identified in the column titled ‘Enrichment ID’ by Hashed Enrichment ID1 and Hashed Enrichment ID2, respectively. By maintaining data lake 117 at user device 104, the pseudonymized data remains in the user's environment without needing to be sent outside that environment, such as to computing device 112, to enable data enrichment.

Third-party systems 118 may include, access, support, and/or host any applications and/or data through any delivery paradigm, including but not limited to remote or distributed cloud computing solutions, local or on-premises software (“on-premise” cloud-based solutions), cloud-based services, “as a service” models (e.g., content as a service (CaaS), digital content as a service (DCaaS), software as a service (SaaS), managed software as a service (MSaaS), platform as a service (PaaS), backend as a service (BaaS), mobile backend as a service (MBaaS), infrastructure as a service (IaaS), etc.), and/or the like. Third-party systems 118 may include and/or support systems including, but not limited to, commercial entities (e.g., merchant devices, e-commerce platforms, etc.), financial institutions and/or finance-supporting institutions (e.g., banks, credit card companies, government agencies, etc.), and/or the like that interact with user device 104. Data and/or information communicated between user device 104 and third-party systems 118 may be collected and communicated to user device 104 via data enrichment module 110. User device 104 may use data enrichment module 110 to enrich user data based on data/information from third-party systems 118. In some aspects, third-party system 118 may utilize additional instances of user device 104 (each containing heir own communication module 106, interface module 108, data enrichment module 110, and data lake 117) to facilitate pseudonymized data enrichment across parties.

According to some aspects of this disclosure, user device 104 may import third-party data from third-party systems 118 to be combined with first-party data (e.g., proprietary data, etc.) generated and/or collected by user device 104. The third-party data may be combined and/or merged with the first-party data using any available data merging and/or data incorporation techniques. When third-party data is combined/merged with first-party data, the combined/merged third-party and first-party data may be combined/enriched with enrichment data (e.g., credit data, digital identity-related data, health-related data, financial data, etc.). The combined third-party and first-party data may be combined/enriched with enrichment data in the same manner as described herein for combining/enriching solely first-party data with enrichment data.

According to some aspects of this disclosure, computing device 112 may include a server, a cloud-based computing resource, or any other device capable of communicating with user device 104, third-party systems 118, and/or any other device/component of system 100, either described or (un) shown. Although shown as a single device, according to some aspects of this disclosure, computing device 112 may be part of a computing system and/or infrastructure, and/or may represent a plurality of computing devices. For example, computing device 112 may represent a plurality of computing devices in communication with user device 104, third-party systems 118, and/or any other device/component of system 100.

According to some aspects of this disclosure, computing device 112 may include communication module 114 that facilitates and/or enables communication with network 102 (e.g., devices, components, and/or systems of network 102, etc.), user device 104, third-party systems 118, and/or any other device/component of system 100. For example, communication module 114 may include hardware and/or software to facilitate communication. According to some aspects of this disclosure, communication module 114 may include one or more of a modem, transceiver (e.g., wireless transceiver, etc.), digital-to-analog converter, analog-to-digital converter, encoder, decoder, modulator, demodulator, tuner (e.g., QAM tuner, QPSK tuner), and/or the like. According to some aspects of this disclosure, communication module 114 may include any hardware and/or software necessary to facilitate communication.

According to some aspects of this disclosure, computing device 112 may include a data enrichment module 116 to facilitate pseudonymized data enrichment. Data enrichment module 116 may include any interface for communicating information, such as pseudonymized enrichment data (e.g., credit data, digital identity-related data, health-related data, financial data, etc.) to/from a user/user device (e.g., user device 104, etc.).

According to some aspects of this disclosure, enrichment module 116 and/or enrichment module 110, included with user device 104, may operate alone or in concert to send data/information to/from user device 104 and computing device 112. For example, enrichment module 110 and enrichment module 116 may be configured via an application operating on user device 104 and computing device 112, respectively, but perform similar and different functions on the devices.

For example, data enrichment module 116 may include software, such as an application and/or the like configured with computing device 112. Data enrichment module 116 may be a portion of an application architecture (e.g., a client-server model, etc.) that enables data enrichment module 110 of user device 104 to communicate with computing device 112. Data enrichment module 116 and data enrichment module 110 may be separate domains within an application. Different entities may control data enrichment module 116 and data enrichment module 110. For example, data enrichment module 110 may be developed and serviced by a pseudonymized data provider and may be an API extension of data enrichment module 116. According to some aspects of this disclosure, data enrichment module 110 may include an API explicitly designed to communicate with data enrichment module 116.

According to some aspects of this disclosure, data enrichment module 116 operates as an intermediary to facilitate the exchange of information (e.g., via API calls, etc.) between data enrichment module 110 of user device 104 and third-party systems 118. Data enrichment module 116 may facilitate the exchange of pseudonymized user information between user device 104 and third-party systems 118.

In an example scenario, user device 104, operating in a first data environment, may generate a request for enrichment data that includes a user identifier(s) for user data to be enriched. The first data environment may forward the request to data enrichment module 116 of computing device 112 operating in a second data environment via a secure application programming interface (API) of data enrichment module 110. The secure API may implement token-based authentication (e.g., OAuth, JSON Web Token (JWT), etc.) and encrypt data communicated between the first and second data environments.

According to some aspects of this disclosure, data enrichment module 116 may not receive an actual/original user identifier from user device 104. Instead, data enrichment module 116 may receive a pseudonymized version of the user identifier to maintain user privacy. The user identifier(s) may be pseudonymized, such that the user identifier(s) is replaced with a pseudonymized representation to protect user identity. For example, if an email address for a user is ‘jane.doe@example.com’, it could be replaced with a random string including, but not limited to, ‘user1234@pseudo.com’ and/or the like.

For example, the user identifier(s) may be pseudonymized by data enrichment module 110 to generate encryption keys. According to some aspects of this disclosure, data enrichment module 110 may pseudonymize the user identifier(s) based on a hashing function (and/or hashing rule) and/or the like that is shared with data enrichment module 116 to pseudonymize enrichment data and/or decrypt pseudonymized data. Computing device 112 may store and/or access enrichment data relevant to the user.

According to some aspects of this disclosure, computing device 112, using data enrichment module 116, may use the pseudonymized version of the user identifier to retrieve relevant enrichment data. For example, computing device 112 may store and/or maintain indexing tables for encryption keys (e.g., pseudonymized versions of the user identifier, etc.) and pseudonymized enrichment data. Separation between indexing tables enables secure data linking without exposing sensitive information. An encryption key table may include mappings between a user identifier (e.g., user ID) and a corresponding encryption key used to encrypt or decrypt sensitive data. A pseudonymized data table may include mappings between pseudonymized user identifiers and the corresponding pseudonymized enrichment data. A generated pseudonym may indirectly link the encryption key table and the pseudonymized enrichment data table. Pseudonymized enrichment data may be encrypted using an encryption key that corresponds to the pseudonymized user identifier.

Computing device 112, using data enrichment module 116, may send the encrypted data file to user device 104 via the secure API. User device 104 may decrypt the encrypted file using the encryption key. The decrypted data may be a pseudonymized representation of the enrichment data to ensure that it can be linked to the user without exposing sensitive information or the user's actual identity. For example, the pseudonymized representation of the enrichment data may be data relevant to a group of which the user is a part, such that trends and insights may be determined for the group (and thus the user) without knowing the specific credit information for any single user. In this way, pseudonymized enrichment data remains in the environment of user device 104 without needing to be sent to computing device 112 to enable data enrichment. Instead, only the pseudonymized PII is sent to computing device 112 to create the tokenized linkage and identity graph 120 back in the environment of user device 104.

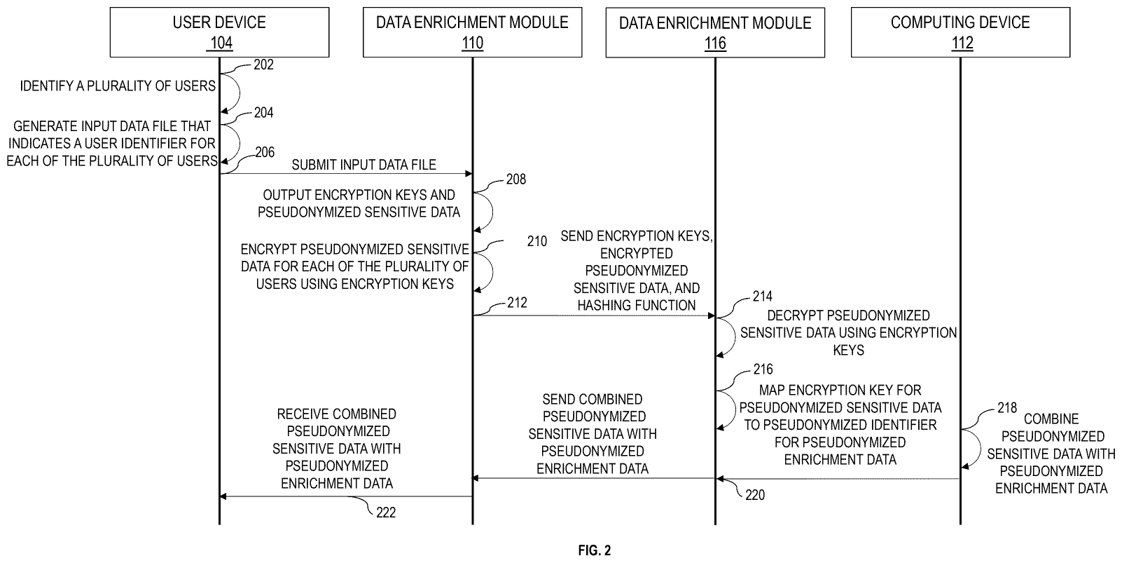

FIG. 2 is a flowchart for an example method 200 for pseudonymized data enrichment, according to aspects of this disclosure. Method 200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously or in a different order than shown in FIG. 2, as will be understood by a person of ordinary skill in the art.

Method 200 shall be described with reference to FIG. 1. However, method 200 is not limited to FIG. 1 or related aspects. As described herein, data enrichment module 110 and data enrichment module 116 may operate to pseudonymize user data (e.g., input data sets, etc.) from user device 104 and append/assign an encryption key (e.g., a pseudonymized user ID, etc.) to link enrichment data (e.g., Fair Credit Reporting Act (FCRA) credit data, digital identity-related data, health-related data, financial data, etc.) to user data. Although enrichment module 110 may be configured with user device 104 and enrichment module 116 may be configured with computing device 116, enrichment module 110 and enrichment module 116 may operate in concert to send information to/from user device 104 and computing device 112. For example, enrichment module 110 and enrichment module 116 may be configured via an application operating on user device 104 and computing device 112, respectively, but perform both similar and different functions on the devices.

In 202, user device 104 identifies a plurality of users for data enrichment.

In 204, user device 104 generates an input data file that indicates respective user identifiers for each of the plurality of users and sensitive data (e.g., PII data, user name, address, city, state, ZIP Code, social security number, date of birth, etc.) associated with the respective user identifiers. According to some aspects of this disclosure, the input file may also include payload data. Payload data may include any collected user data (e.g., first-party data, performance attributes, scores, meaningful data, etc.) to be enriched with other data sets.

In 206, user device 104 submits the input file to data enrichment module 110 (e.g., via a user interface of data enrichment module 110, etc.).

In 208, data enrichment module 110 processes the input file and outputs a respective encryption key and respective pseudonymized sensitive data for each user of the plurality of users. The respective encryption key for each user of the plurality of users may be a pseudonymized representation of a respective user identifier.

According to some aspects of this disclosure, to generate the respective pseudonymized sensitive data, data enrichment module 110 may use the same information used for the hashing function (and/or hashing rule) used to generate the respective encryption key for each user of the plurality of users, but with different parameters (e.g., salt values, etc.). The payload may also be pseudonymized. Pseudonymization may include tokenizing the respective user identifiers and sensitive data for each user of the plurality of users via hash functions including, but not limited to, Secure Hash Algorithm 256 (SHA-256), Secure Hash Algorithm 3 (SHA-3), BLAKE2, Whirlpool, Argon2, Scrypt, Hash-Based Message Authentication Code (HMAC), and/or the like. According to some aspects of this disclosure, user device 104 may specify a hashing function to be used. According to some aspects of this disclosure, data enrichment module 110 may include a predictive model that identifies/recommends a hashing function based on the type of user data provided by user device 104. According to some aspects of this disclosure, any hashing function may be used.

In 208, data enrichment module 110 outputs encrypted keys and pseudonymized enrichment data.

In 210, data enrichment module 110 outputs encrypted keys and the pseudonymized personally identifying information for each user of the plurality of users using the respective encryption key.

In 212, data enrichment module 110 sends the respective encryption key and the respective pseudonymized sensitive data for each user of the plurality of users to data enrichment module 116 for matching and linking. An indication of the hashing function may be shared with data enrichment module 116.

In 214, data enrichment module 116 decrypts the respective pseudonymized sensitive data for each user of the plurality of users using the respective encrypted key.

In 216, computing device 112 (with data enrichment module 116) sends the mapping of pseudonymized user identifiers for each user of the plurality of users to the user device 104.

In 218, user device 104 (with data enrichment module 110) receives the mapping. For example, data enrichment module 110 may provide an interface for user device 104 to download, view, manipulate, access, and/or the like for the mapping.

In 220, data enrichment module 110 identifies a mapping between the respective encrypted key (e.g., pseudonymized user identifier) and a pseudonymized enrichment identifier to identify respective pseudonymized enrichment data in a data lake (e.g., as shown by indexing table 120 of data lake 117 in FIG. 1).

In 222, user device 104 combines the respective pseudonymized sensitive data for each user of the plurality of users with the respective pseudonymized enrichment data.

According to some aspects of this disclosure, user device 104 may apply one or more analytics and/or machine learning algorithms to derive valuable insights from the combined respective pseudonymized sensitive data and respective pseudonymized enrichment data for each user of the plurality of users. These insights may be utilized to enhance an entity's services, personalize user experiences, inform business strategies, and/or the like. For example, user device 104 may aggregate and analyze the combined respective pseudonymized sensitive data and respective pseudonymized enrichment data for each user of the plurality of users to generate custom analytics (e.g., unique group-level patterns, etc.). User device 104 may utilize data analysis tools to perform statistical analysis clustering and behavioral analysis, time-series analysis, machine learning, and/or the like to identify trends, correlations, and/or other key metrics among a group of users. For security, since the combined data is pseudonymized, individual user-level analysis may be prevented. User device 104 may use a user interface to display results from analysis of the combined data.

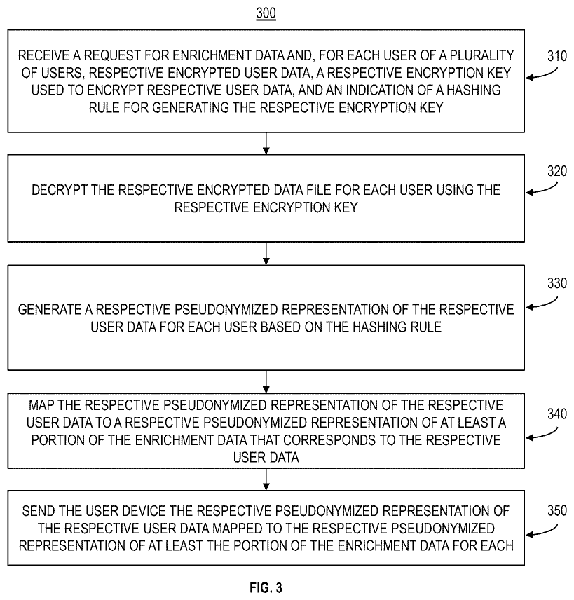

FIG. 3 is a flowchart for an example method 300 for pseudonymized data enrichment, according to aspects of this disclosure. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously or in a different order than shown in FIG. 3, as will be understood by a person of ordinary skill in the art.

Method 300 shall be described with reference to FIG. 1. However, method 300 is not limited to those figures or related aspects.

In 310, computing device 112 receives a request for enrichment data for enriching user data, an encryption key used to encrypt the user data, the encrypted user data, and an indication of a hashing rule for generating the encryption key. For example, computing device 112 may receive the a request for the enrichment data, the encryption key, the encrypted user data, and the indication of the hashing rule from a user device (e.g., user device 104, etc.) within a first data environment. The encryption key may be generated according to the hashing rule (e.g., a hashing function, etc.) and may be a pseudonymized representation of a user identifier (e.g., a unique user ID, an email, a phone number, a social security number, etc.) associated with the user data. According to some aspects of this disclosure, the enrichment data may include, but is not limited to, regulated credit data, digital identity-related data, health-related data, financial data, and/or the like.

Computing device 112 may receive the encryption key, the encrypted user data, and the indication of the hashing rule based on the request for the enrichment data. For example, the encryption key and the encrypted user data may be generated within the first data environment based on an interaction with a user interface displayed by the user device. The user device may send an encrypted data file that includes the user data to computing device 112 via a secure application programming interface (API) that enables access to the second data environment.

In 320, computing device 112 decrypts the encrypted user data within the second data environment. Computing device 112 may use the encryption key to decrypt the encrypted user data within the second data environment.

In 330, computing device 112 generates a pseudonymized representation of the user data for each user. The pseudonymized representation of the user data may be linked to the encryption key. Computing device 112 may generate the pseudonymized representation of the user data based on the hashing rule applied to the decrypted user data. According to some aspects of this disclosure, based on the hashing rule, pseudonyms used to represent the decrypted user data may be derived from the same information used to generate the encryption key, but with different parameters (e.g., salt values, etc.) so that the pseudonymized representation of the decrypted user data is linked to the encryption key. The pseudonymized representation of the decrypted user data may be linked to the encryption key using a secure reference table that is stored securely by computing device 112 within the second data environment.

According to some aspects of this disclosure, computing device 110 may use any other techniques including, but not limited to, tokenization, data masking, and/or the like to generate the pseudonymized representation of at least the portion of the decrypted representation of the user data and link it to the encryption key. For example, to generate the pseudonymized representation of at least the portion of the decrypted representation of the user data via tokenization, computing device 112 may generate tokens for the portions of the decrypted representation of the user data to replace sensitive data. Computing device 112 may generate mappings (e.g., a look up table, etc.) between the tokens and the original portions of the decrypted representation of the user data. For security, computing device 112 may store the mappings in an encrypted database and/or data lake of the second data environment.

In 340, computing device 112 maps the pseudonymized representation of the user data to a pseudonymized representation of at least a portion of the enrichment data that corresponds to the user. Computing device 112 may identify the pseudonymized representation of at least the portion of the enrichment data based on the encryption key mapped to a pseudonymized representation of an identifier of at least the portion of the enrichment data. According to some aspects of this disclosure, the pseudonymized representation of at least the portion of the enrichment data may be pseudonymized using a pseudonym(s) (or token(s)) consistent with the pseudonymized representation of the user data. According to some aspects of this disclosure, the pseudonymized representation of at least the portion of the enrichment data may be stored in the encrypted database and/or the data lake of the second data environment, inaccessible to the user device. By isolating the user device from the enrichment data and pseudonymizing the enrichment data, security and privacy of the enrichment data within the data lake may be maintained.

In 350, computing device 112 sends the pseudonymized representation of the user data mapped to the pseudonymized representation of at least the portion of the enrichment data to the user device within the first data environment. The computing device 112 may send the pseudonymized representation of the user data mapped to the pseudonymized representation of at least the portion of the enrichment data to the user device via the secure API. According to some aspects of this disclosure, to maintain confidentiality and integrity of the combined data during transit, the pseudonymized representation of the user data mapped to the pseudonymized representation of at least the portion of the enrichment data may be encrypted prior to being sent to the user device. Another encryption key that may be used to decrypt the encrypted, pseudonymized representation of the user data mapped to the pseudonymized representation of at least the portion of the enrichment data may be sent the user device. According to some aspects of this disclosure, computing device 112 may send the other encryption key to the user device separate from the pseudonymized representation of the user data mapped to the pseudonymized representation of at least the portion of the enrichment data during a randomized time interval.

According to some aspects of this disclosure, user device 104 may aggregate and analyze the pseudonymized representation of the user data mapped to the pseudonymized representation of at least the portion of the enrichment data to generate custom analytics (e.g., unique group-level patterns, etc.). The user device may utilize data analysis tools to perform statistical analysis clustering and behavioral analysis, time-series analysis, machine learning, and/or the like to identify trends, correlations, and/or other key metrics. For security, since the aggregated data is pseudonymized, individual user-level analysis may be prevented. The user device may use a user interface to display results from analysis of the combined data.

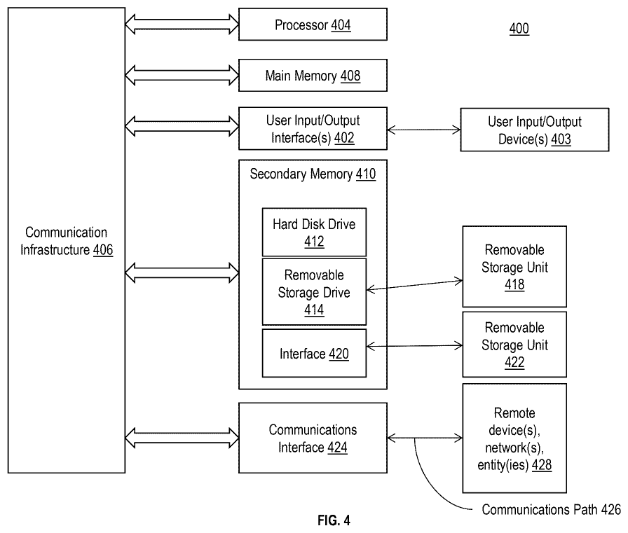

Various aspects of this disclosure may be implemented, for example, using one or more well-known computer systems, such as computer system 700 shown in FIG. 4. One or more computer systems 400 may be used, for example, to implement any of the aspects discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). According to some aspects of this disclosure, a GPU may be a specialized electronic circuit processor designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, a tape backup device, and/or any other storage device/drive.

Removable storage drive 414 may interact with a removable storage unit 418. Removable storage unit 418 may include a computer-usable or readable storage device having stored thereon computer software (control logic) and/or data. Removable storage unit 418 may be a floppy disk, magnetic tape, compact disk, DVD, optical storage disk, and/or any other computer data storage device. Removable storage drive 414 may read from and/or write to removable storage unit 418.

Secondary memory 410 may include other means, devices, components, instrumentalities, or other approaches for allowing computer programs and/or other instructions and/or data to be accessed by computer system 400. Such means, devices, components, instrumentalities, or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof) and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smartphone, smartwatch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

According to some aspects of this disclosure, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use various aspects of this disclosure using data processing devices, computer systems, and/or computer architectures other than that shown in FIG. 4. In particular, various aspects described herein can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other aspects, examples, embodiments, and/or modifications thereto are possible and are within the scope and spirit of this disclosure. For example, and without limiting the generality of this paragraph, aspects, examples, and/or embodiments are not limited to the software, hardware, firmware, and/or entities illustrated in the figures and/or described herein. Further, embodiments (whether or not explicitly described herein) have significant utility to fields and applications beyond the examples described herein.

Various aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “an aspect,” “an example,” “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expressions “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still cooperate or interact with each other.

The breadth and scope of this disclosure should not be limited by any of the above-described exemplary embodiments, but should be defined only in accordance with the following claims and their equivalents.

What is claimed is:

1. A method comprising:
receiving, from a user device within a first data environment via a secure application programming interface (API) that enables access to a second data environment within which enrichment data for respective user data for each user of a plurality of users is stored, a request for the enrichment data and, for each user of the plurality of users, a respective encryption key used to encrypt the respective user data, respective encrypted user data, and an indication of a respective hashing rule used to generate the respective encryption key, wherein the respective encryption key is a pseudonymized representation of a respective user identifier associated with the respective user data;
for each user of the plurality of users:
decrypting, based on the respective encryption key, the respective encrypted user data within the second data environment,
generating, based on the respective hashing rule applied to the respective decrypted user data, a respective pseudonymized representation of the respective user data, and
mapping the respective pseudonymized representation of the respective user data to a respective pseudonymized representation of at least a portion of the enrichment data that corresponds to the respective user data, wherein the respective pseudonymized representation of at least the portion of the enrichment data is identified based on the respective encryption key mapped to a respective pseudonymized representation of a respective identifier of at least the portion of the enrichment data; and
sending, to the user device within the first data environment via the secure API, the respective pseudonymized representation of the respective user data mapped to the respective pseudonymized representation of at least the portion of the enrichment data for each user of the plurality of users.

2. The method of claim 1, wherein the enrichment data for the respective user data for each user of the plurality of users comprises at least one of: regulated credit data, digital identity-related data, health-related data, or financial data.

3. The method of claim 1, further comprising generating the respective encryption key based on a hashing rule applied to the user identifier.

4. The method of claim 1, wherein the respective pseudonymized representation of the respective user data for each user of the plurality of users is stored in a data lake of the second data environment that is inaccessible to the user device.

5. The method of claim 1, wherein the request for the enrichment data is generated within the first data environment based on an interaction with a user interface displayed by the user device.

6. The method of claim 1, wherein the respective pseudonymized representation of at least the portion of the enrichment data for each user of the plurality of users is selected to be pseudonymized from additional enrichment data based on a type of entity associated with the user device.

7. The method of claim 1, wherein the first data environment and the second data environment are controlled by different entities.

8. A system, comprising:
a memory; and
at least one processor coupled to the memory and configured to perform operations comprising:
receiving, from a user device within a first data environment via a secure application programming interface (API) that enables access to a second data environment within which enrichment data for respective user data for each user of a plurality of users is stored, a request for the enrichment data and, for each user of the plurality of users, a respective encryption key used to encrypt the respective user data, respective encrypted user data, and an indication of a respective hashing rule used to generate the respective encryption key, wherein the respective encryption key is a pseudonymized representation of a respective user identifier associated with the respective user data;
for each user of the plurality of users:
decrypting, based on the respective encryption key, the respective encrypted user data within the second data environment,
generating, based on the respective hashing rule applied to the respective decrypted user data, a respective pseudonymized representation of the respective user data, and
mapping the respective pseudonymized representation of the respective user data to a respective pseudonymized representation of at least a portion of the enrichment data that corresponds to the respective user data, wherein the respective pseudonymized representation of at least the portion of the enrichment data is identified based on the respective encryption key mapped to a respective pseudonymized representation of a respective identifier of at least the portion of the enrichment data; and
sending, to the user device within the first data environment via the secure API, the respective pseudonymized representation of the respective user data mapped to the respective pseudonymized representation of at least the portion of the enrichment data for each user of the plurality of users.

9. The system of claim 8, wherein the enrichment data for the respective user data for each user of a plurality of users comprises at least one of: regulated credit data, digital identity-related data, health-related data, or financial data.

10. The system of claim 8, the operations further comprising generating the respective encryption key based on a hashing rule applied to the user identifier.

11. The system of claim 8, wherein the respective pseudonymized representation of the respective user data for each user of the plurality of users is stored in a data lake of the second data environment that is inaccessible to the user device.

12. The system of claim 8, wherein the request for the enrichment data is generated within the first data environment based on an interaction with a user interface displayed by the user device.

13. The system of claim 8, wherein the respective pseudonymized representation of at least the portion of the enrichment data for each user of the plurality of users is selected to be pseudonymized from additional enrichment data based on a type of entity associated with the user device.

14. The system of claim 8, wherein the first data environment and the second data environment are controlled by different entities.

15. A non-transitory computer-readable medium having instructions stored thereon that, when executed by at least one computing device, causes the at least one computing device to perform operations comprising:
receiving, from a user device within a first data environment via a secure application programming interface (API) that enables access to a second data environment within which enrichment data for respective user data for each user of a plurality of users is stored, a request for the enrichment data and, for each user of the plurality of users, a respective encryption key used to encrypt the respective user data, respective encrypted user data, and an indication of a respective hashing rule used to generate the respective encryption key, wherein the respective encryption key is a pseudonymized representation of a respective user identifier associated with the respective user data;
for each user of the plurality of users:
decrypting, based on the respective encryption key, the respective encrypted user data within the second data environment,
generating, based on the respective hashing rule applied to the respective decrypted user data, a respective pseudonymized representation of the respective user data, and
mapping the respective pseudonymized representation of the respective user data to a respective pseudonymized representation of at least a portion of the enrichment data that corresponds to the respective user data, wherein the respective pseudonymized representation of at least the portion of the enrichment data is identified based on the respective encryption key mapped to a respective pseudonymized representation of a respective identifier of at least the portion of the enrichment data; and
sending, to the user device within the first data environment via the secure API, the respective pseudonymized representation of the respective user data mapped to the respective pseudonymized representation of at least the portion of the enrichment data for each user of the plurality of users.

16. The non-transitory computer-readable medium of claim 15, wherein the enrichment data for the respective user data for each user of a plurality of users comprises at least one of: regulated credit data, digital identity-related data, health-related data, or financial data.

17. The non-transitory computer-readable medium of claim 15, the operations further comprising generating the encryption key based on a hashing function applied to the user identifier.

18. The non-transitory computer-readable medium of claim 15, wherein the respective pseudonymized representation of the respective user data for each user of the plurality of users is stored in a data lake of the second data environment that is inaccessible to the user device.

19. The non-transitory computer-readable medium of claim 15, wherein the request for the enrichment data is generated within the first data environment based on an interaction with a user interface displayed by the user device.

20. The non-transitory computer-readable medium of claim 15, wherein the respective pseudonymized representation of at least the portion of the enrichment data for each user of the plurality of users is selected to be pseudonymized from additional enrichment data based on a type of entity associated with the user device.
